(19) United States
(12) Patent Application Publication
(10) Pub. No.: US 2007/0152626 A1
(43) Pub. Date: Jul. 5, 2007

(54) Method for Regulating an Electric Boat Motor

(75) Inventor: Friedrich Boebel, Eurasburg (DE)

Correspondence Address: CROWELL & MORING LLP;INTELLECTUAL PROPERTY GROUP, P.O. BOX 14300, WASHINGTON, DC, 20044-4300, US

(73) Assignee: TORQEEDO GMBH, Starnberg (DE)

(21) Appl. No.: 11/619,382

(22) Filed: Jan. 3, 2007

(30) Foreign Application Priority Data
Jan. 5, 2006 (DE) 102006001009.4
Feb. 27, 2006 (EP) 06003968.2

(51) Int. Cl. H02J 7/00

(52) U.S. Cl. 320/104

(57) ABSTRACT

The invention relates to a method for regulating an electric boat motor, which is supplied with current by a battery, up to the maximum current being drawn from the battery, the battery voltage being measured and the maximum current being reduced if the battery voltage falls below a limit voltage.

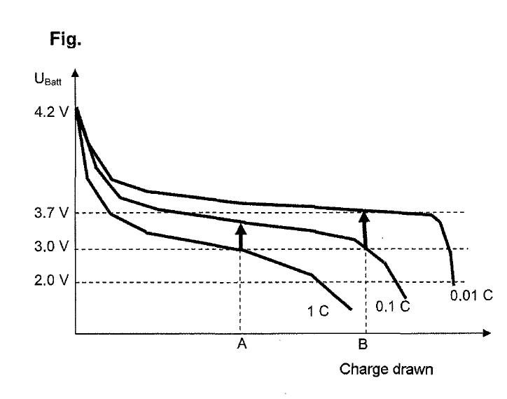

### BACKGROUND AND SUMMARY OF THE INVENTION

The present invention relates to a method for increasing the range of a boat which is driven by an electric boat motor, the electric boat motor being supplied with current by a battery, at most a maximum current being drawn from the battery. In addition, the invention relates to an apparatus for increasing the range of a boat which is driven by an electric boat motor, the electric boat motor being supplied with current by a battery, comprising a current limitation unit for limiting the current drawn from the battery to a maximum current, and to a boat having an electric boat motor and a battery, which supplies the electric boat motor with current.

Owing to relatively strict environment protection regulations, boats with electric drives are increasingly used on lakes and also in coastal regions. In comparison with internal combustion engines, these have the advantage of producing little noise and of not contaminating the water, which is otherwise in particular the case with two-stroke internal combustion engines.

The electrical energy required for operating electric motors is made available by batteries. However, batteries are comparatively large and heavy, with the result that only a limited number of batteries can be accommodated on the boat. Correspondingly, the range of an electrically driven boat is limited by the capacity of the battery.

The residual capacity of the battery should be large enough for the boat to still reach a safe starting point, for example a harbor, and not to be driven on the water with no maneuverability.

An object of the present invention is therefore to indicate a method and an apparatus for regulating an electric boat motor, which makes an increased residual range of the boat possible with the given residual capacity of the battery.

This object is achieved by a method of the type mentioned at the outset, in which the battery voltage is measured and the maximum current is reduced if the battery voltage falls below a limit voltage.

The apparatus according to the invention for increasing the range of a boat which is driven by an electric boat motor, the electric boat motor being supplied with current by a battery, includes a current limitation unit for limiting the current drawn from the battery to a maximum current and is characterized by the fact that a voltage measuring device for determining the battery voltage and a control unit connected to the voltage measuring device are provide. The control unit compares the battery voltage with a limit voltage and, for the case in which the battery voltage is lower than the limit voltage, drives the current limitation unit and reducing the maximum current.

The invention is based on the recognition that the battery voltage can be used as an indicator for the residual capacity. It has been established that the battery voltage depends firstly on the state of charge of the battery and secondly on the current consumption. After the charging process, the battery voltage has a maximum value, referred to below as the end-of-charge voltage. As the battery continues to discharge, the battery voltage slowly decreases until the voltage fails. The battery voltage is, however, also dependent on the current consumption. The greater the amount of current drawn from the battery, the lower the battery voltage is.

This twofold dependency of the battery voltage on the state of charge of the battery, on one hand, and on the current consumption, on the other hand, is used according to the invention for increasing the residual range of an electric motor boat, whose electric motor is supplied by a battery.

For this purpose, the battery voltage is measured and compared with a predetermined value, referred to below as the limit voltage. If the present battery voltage falls below the limit voltage, this is an indicator of a low residual capacity of the battery. According to the invention, in this case the electric motor is switched over to a more economic mode of operation. The maximum current drawn from the battery is limited to a maximum current which is lower than the maximum current previously drawn from the battery.

Owing to the lower current consumption, a greater residual range can be achieved with the given residual capacity of the battery. The electric motor is operated more economically.

When the battery voltage falls below the limit voltage once again, the maximum current is advantageously in turn reduced. This can take place many times, with the result that the electric motor is switched over to an ever slower and more economic mode of operation in stepwise fashion.

It is also advantageous to provide a plurality of limit voltages, the maximum current being reduced in a first stage if the battery voltage falls below the largest of the limit voltages. The current consumption is restricted to this new maximum current until the battery voltage falls below the second lower limit voltage. A further reduction in the maximum current then takes place.

A gradual and more uniform switchover from the rapid travel mode to the more economic, slower travel mode is thus achieved for optimum utilization of the residual capacity of the battery.

The method according to the invention is particularly suitable for regulating electric boat motors which are supplied by batteries capable of high currents, in particular lithium batteries, very particularly preferably by a lithium-manganese battery.

Sometimes, batteries, for example lithium-manganese batteries, are damaged irreversibly if the battery voltage falls below a minimum value. It is therefore advantageous to interrupt the current flow from the battery completely when the voltage falls below a predetermined minimum voltage, i.e. in particular to switch the electric boat motor off. The minimum voltage is selected to be large enough for no damage to occur yet on the battery.

### BRIEF DESCRIPTION OF THE DRAWINGS

The invention and further details of the invention will be explained in more detail below with reference to the exemplary embodiment illustrated in the drawings, in which:

The sole FIGURE is a graph showing the dependency of the battery voltage on the charge drawn from a lithium-manganese battery.

### DETAILED DESCRIPTION OF THE DRAWING

The FIGURE illustrates the dependency of the battery voltage of a lithium-manganese battery as a function of its state of charge, i.e. the charge drawn, for three different current consumptions. The curve denoted by “1 C” shows this dependency for the case in which such a current is drawn from the battery that its capacity is exhausted in one hour. The curves identified by “0.1 C” and “0.01 C” correspondingly show the profile of the battery voltage if a 0.1-fold or a 0.01-fold current is drawn from the battery.

The lithium-manganese battery is used for supplying current to a boat electric motor, in particular for supplying an electronically commutated synchronous motor.

After the charging process, the battery has an end-of-charge voltage of 4.2 V. The rated voltage of the lithium-manganese cells is 3.7 V. The boat motor is initially operated with a charged battery at a maximum current of 1 C, i.e., at a battery capacity of, for example, 100 Ah, at most a current of 100 A is drawn.

The battery voltage is continuously monitored during the motor operation. If the battery voltage falls below a predetermined limit voltage of 3.0 V, this is an indication of the fact that the capacity of the battery will shortly be exhausted with this continuously high level of current consumption. According to the invention, the maximum current to be drawn from the battery is therefore restricted to 0.1 C at this point A. This means that the electric motor is switched over to a slower, but more economical travel mode.

The curve “0.1 C” clearly shows that, with this mode of operation, more charge can be drawn from the battery before the voltage fails. For the boat this means that it can cover a greater residual range with the same residual capacity.

If the battery voltage falls below the limit voltage of 3.0 V even in this already throttled mode of travel, the maximum current is reduced once again, in the illustrated case to 0.01 C.

If the battery voltage is now only 2.0 V, the motor is switched off for safety reasons in order to avoid complete discharge of and damage to the batteries.

I claim:

1. A method for increasing the range of a boat driven by an electric boat motor, comprising supplying the electric boat motor with current from a battery, drawing up to the maximum current from the battery, measuring the battery voltage, and reducing maximum current if the battery voltage falls below a limit voltage.

2. The method as claimed in claim 1, wherein, when the battery voltage falls below the limit voltage once again, the maximum current is reduced again.

3. The method as claimed in claim 1, wherein two limit voltages are predetermined and the maximum current is reduced to a first maximum value if the battery voltage falls below the first limit voltage, and the maximum current is reduced to a second maximum value if the battery voltage falls below the second limit voltage.

4. The method as claimed claim 1, wherein the electric boat motor is supplied with current from a lithium battery with high current capacity.

5. The method as claimed in claim 4, wherein the electric boat motor is supplied with current from a lithium-manganese battery.

6. The method as claimed in claim 1, wherein current is not drawn from the battery if the battery voltage falls below a minimum voltage.

7. An apparatus for increasing the range of a boat driven by an electric boat motor, with the electric boat motor being supplied with current by a battery, comprising a current limitation unit for limiting the current drawn from the battery to a maximum current, a voltage measuring device for determining the battery voltage and a control unit connected to the voltage measuring device, wherein the control unit compares the battery voltage with a limit voltage and, for the case in which the battery voltage is lower than the limit voltage, drives the current limitation unit and reduces the maximum current.

8. A boat having an electric boat motor and a battery that supplies the electric boat motor with current, wherein an apparatus for increasing the range of the boat, said apparatus comprising a current limitation unit for limiting the current drawn from the battery to a maximum current, a voltage measuring device for determining the battery voltage and a control unit connected to the voltage measuring device, wherein the control unit compares the battery voltage with a limit voltage and, for the case in which the battery voltage is lower than the limit voltage, drives the current limitation unit and reduces the maximum current.
